(19) United States
(12) Patent Application Publication
(10) Pub. No.: US 2009/0256435 A1
(43) Pub. Date: Oct. 15, 2009

(54) Device and Method to Clamp and Lock Permanent Magnets and Improve Cooling within a Rotating Electrical Machine

(75) Inventor: Carlos Gottfried, Mexico (MX)

Correspondence Address: Arthur M Dula, 3106 Beauchamp Street, Houston, TX, 77009, US

(73) Assignee: POWER GROUP INTERNATIONAL, INC., Laredo, TX (US)

(21) Appl. No.: 11/990,955

(22) PCT Filed: Aug. 25, 2006
(86) PCT No.: PCT/US2006/033307

§ 371 Date: Feb. 25, 2009

Related U.S. Application Data
(60) Provisional application No. 60/711,243, filed on Aug. 25, 2005.

(51) Int. Cl. H02K 1/32; H02K 1/27; H02K 15/03

(52) U.S. Cl. 310/61; 310/156.19; 29/598

(57) ABSTRACT

A device to hold at least one magnetic flux producing permanent magnet onto a surface of an electrical machine comprising at least one slot recessed from the surface and extending from one end of the surface; and at least one gripping bar inserted into an associated at least one slot having a protrusion extending past the surface to engage at least one magnet where at least one slot and at least one gripping bar are shaped to retain the at least one gripping bar within the associated at least one slot to hold the at least one engaged magnet onto the surface.

### BACKGROUND

1. Field of the Invention

The present invention relates generally to devices and methods for assembling permanent magnet electrical machines, and more particularly to an apparatus and method for mounting the magnets within the machine rotor.

2. General Background and State of the Art

Permanent magnets make it reasonable to build electrical machines (defined here as motors and generators) using these for field generation rather than electro-magnets. Typically the magnets are mounted on an inner rotor, but outer rotor mounting is also used. In a generator, the rotations of the magnetic fields of the magnets on the rotor induce voltages and currents in the radially outward stator. In a motor, the magnets react to voltages and currents applied to the stator and cause rotation of the rotor.

Permanent magnet electrical machines are more compact and simpler and require less maintenance than their electromagnetic brethren by not requiring electromagnet windings. Modern Rare Earth magnets provide a much denser source of powerful magnetic flux than can windings, and have a high flux and are capable of withstanding reasonably high temperatures. The resulting compact machines find application in structures where size, weight and efficiency are important, such as generators within the nacelles of wind power generators located on the top of high towers, or as motors where space is a premium.

Permanent magnets are mounted in the so called surface mount configuration, on the surface of the rotor, where their poles are oriented radially and axially.

One of the manufacturing issues related to permanent magnet machines is the mounting of the magnets to the rotor. Conventionally, the surface mount magnets are mounted by bonding them to the rotor surface. Although the adhesive is typically an epoxy, this alone is often inadequate given the powerful magnetic attraction of the magnets to the ferromagnetic material of the stator, which is separated from them only by a miniscule air gap. Rotor mounting is made even more difficult given the centripetal forces on the magnets due to the rotor rotation; which is true in normal operation, but especially during over-speed. In the case of rotor-mounted magnets, banding with a non-ferrous material (such as fiberglass, carbon fiber or kevlar tape) is also used where the tape is tightly wound around the circumference of the bonded magnets and then heat cured.

A more reliable means to mount surface mounted magnets within electrical machines is needed and is the subject of this invention.

### SUMMARY OF THE INVENTION

Accordingly, it is an object of the present invention to provide a method and device to clamp and lock permanent magnets to the surface of the rotor of an electrical machine.

Cooling electrical machines is always an issue, and a further object of the present invention is to provide a means to cool the rotor.

Further objects and advantages of the present invention will become more apparent for the following description of the preferred embodiments, which, taken in conjunction with the accompanying drawings, will illustrate, by way of example, the principles of the invention.

### BRIEF DESCRIPTION OF THE DRAWINGS

The foregoing and other objects, aspects and advantages will be better understood from the following detailed description of the preferred embodiments of the invention with reference to the drawings in which:

FIG. 1 illustrates the rotor of an electrical machine with magnets bonded to its outer surface;

FIG. 2 illustrates the rotor and stator of an electrical machine in a cross-section with magnets bonded to the rotor surface and also locked in place by “I” beam shaped gripping bars mounted into an axial slots in the rotor structure; the heat transfer and cooling provided by the gripping bar is also illustrated;

FIG. 3 illustrates the rotor and stator of an electrical machine in fragmentary cross-section with magnets bonded to the rotor surface and also locked in place by “I” beam shaped gripping bars mounted into an axial slots in the rotor structure using a step on each magnet; the heat transfer and cooling provided by the gripping bars is also illustrated;

FIG. 4 illustrates the rotor of an electrical machine in fragmentary cross-section with magnets bonded to the rotor surface and also locked in place by double dovetail shaped gripping bar mounted into an axial slot in the rotor structure using magnets having matching surfaces; the heat transfer and cooling provided by the gripping bar is also illustrated;

FIG. 5 illustrates the rotor of an electrical machine in fragmentary cross-section with an “I” shaped gripping bar as it is installed hot and expanded, and then cools and contracts to lock adjacent magnets;

FIG. 6 illustrates the application of surface mounted magnets showing the use of non-ferromagnetic gripping bar;

FIG. 7 illustrates one of many slots in a cast or machined rotor;

FIG. 8 illustrates one of many slot outlines punched onto laminations of a laminated rotor;

FIG. 9 illustrates one of many slot outlines punched onto laminations of a laminated rotor with ventilation gaps between selected laminations at given intervals;

FIG. 10 illustrates a fragmentary cross-section of a vented rotor at a ventilation gap;

FIG. 11 illustrates a vented rotor with two circular rows of permanent magnets held by gripping bars with vents drawing cooling air from a central plenum and having the ventilation gaps between the circular rows of permanent magnets, and;

FIG. 12 illustrates a vented rotor and stator with ventilation gaps at given intervals.

### DETAILED DESCRIPTION OF THE PREFERRED EMBODIMENTS OF THE INVENTION

In the following description of the present invention, reference is made to the accompanying drawings, which form a part thereof, and in which are shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

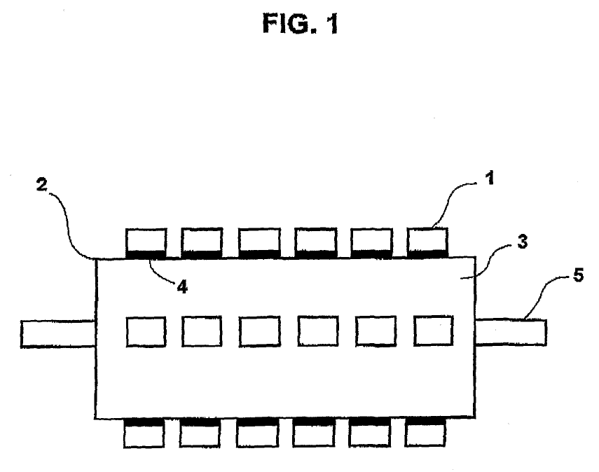

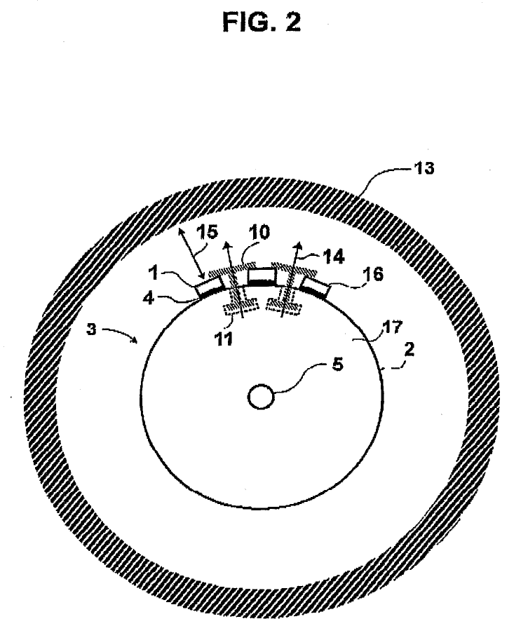

General Magnet Mounting: As illustrated in FIG. 1, the conventional manner to attach the permanent magnets 1 is simply to bond them to the surface 2 of the rotor 3 using adhesive 4. The shaft 5 providing rotor 3 rotation is also shown. A better method, the subject of this invention, is illustrated in FIG. 2 where a gripping bar 10 is locked within the rotor core 17 and engaging the magnets 1. The gripping bar 10, for example, has an “I” beam shaped cross-section and is as long as the rotor 3 with the lower “I” portion slipping into a similarly shaped internal slot 11 formed within the rotor core 17 from which the rotor core 17 and the other end of the gripping bar 10 overlaps two adjacent magnets 1 and so holds them firmly onto the rotor surface 2.

The magnets 1 are bonded onto the surface 2 simply as an assembly step to hold them in place for the gripping bar installation, and rotor banding is not required.

The magnets 1 are simple curved shapes that conform to the rotor surface 2, and the gripping bar 10 simply overlaps the magnet outer radial surface 16. The gripping bar 10 is necessarily closer to the stator 13 than are the magnets 1, and in the air gap 15 between rotor 3 and stator 13.

The gripping bar 10 extension into the rotor core 17 provides a cooling path 14 whereby heat from the surrounding magnets 1 and core 17 is transferred outward.

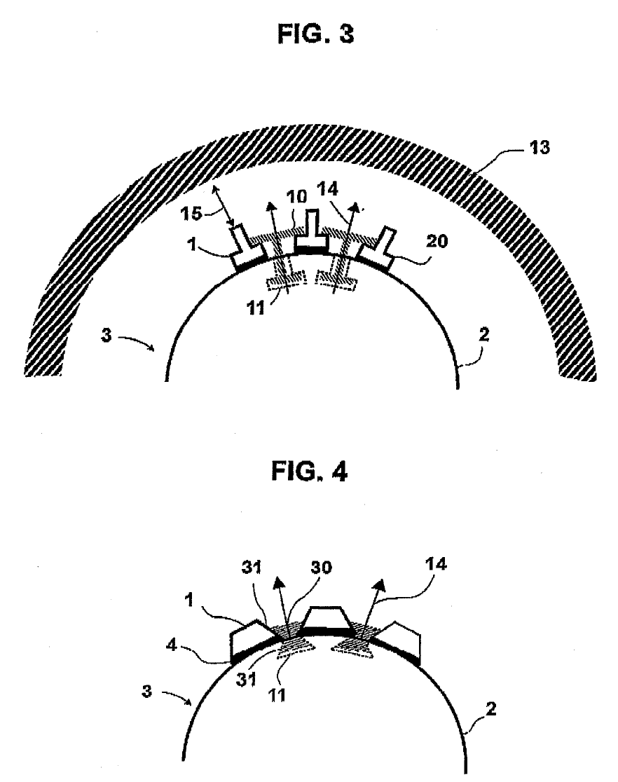

In an alternative embodiment, illustrated in FIG. 3, the magnet 1 shape includes a step 20 to accent the gripping bar 10 that is further from the stator 13 than the magnet 1

In a further embodiment, illustrated in FIG. 4, the gripping bar 10 has a cross-section shaped as a double dovetail 30 where the magnet 1 and the slot 11 have mating surfaces 31.

In a further embodiment the gripping bar 10 has a cross-section shaped as a combination of the “I” and the dovetail.

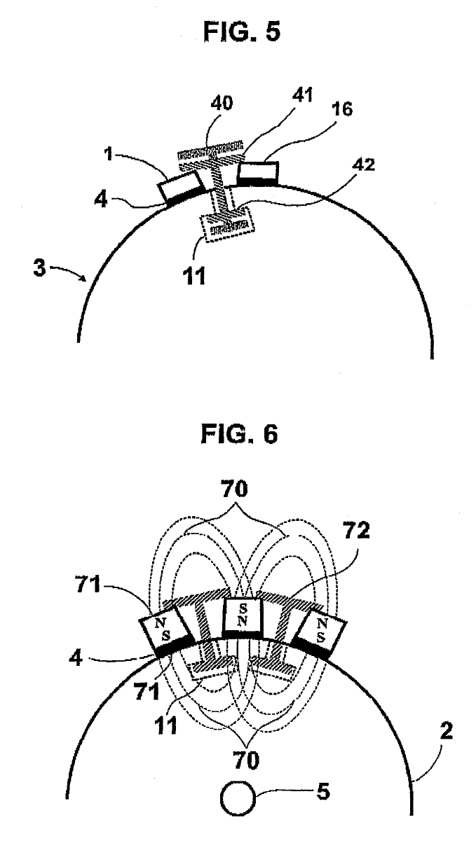

Preferably, the magnets 1 are bonded in place and the gripping bar 10 heated, and thus expanded, and then inserted into the slot 11 while still hot. As illustrated in FIG. 5, the heated gripping bar 40 is expanded and does not hold the magnet 1, but the cool gripping bar 41 contracts and forms a tight grip between the outward radial surface 42 of the slot 11 and the magnets outermost radial surface 16.

As illustrated in FIG. 6, surface mounted magnets have radial poles 71 and, to maintain the desired radial magnetic flux 70 emanating from the poles 71, a non-ferromagnetic gripping bar 72 must be made of non-ferromagnetic material so as not to interfere with the normal magnet flux path 70. The material is aluminum, stainless steel, carbon fiber, poltruded fiberglass or other non-magnetic material.

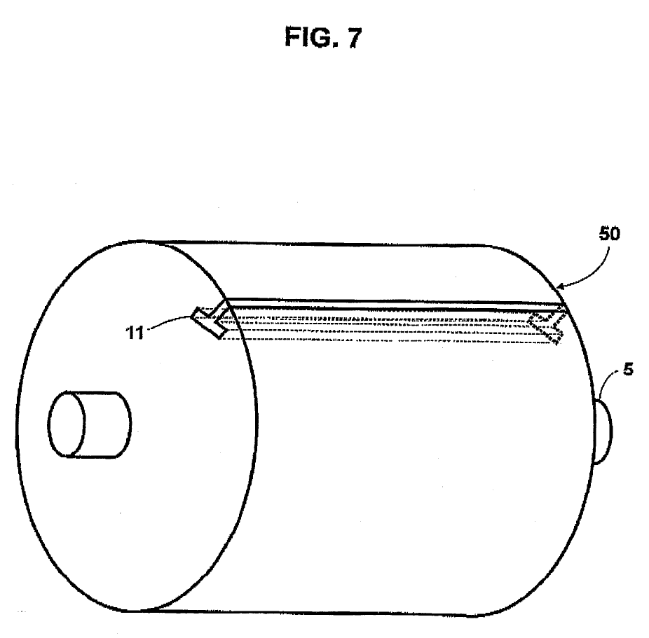

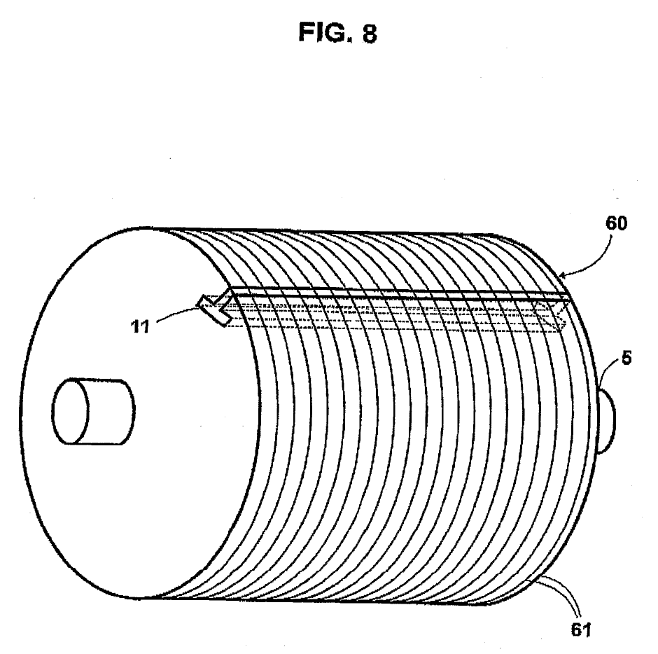

The rotor 3 is either a cast ferrous metal or formed by laminated sections that reduce eddy currents. As illustrated in FIG. 7, for a cast rotor 50 the casting form provides for the internal slots 11 for embedding the gripping bar 10. Alternatively, the slots 11 are machined or milled.

As illustrated in FIG. 8, for a laminated rotor 60 the slot 11 cross-section is punched onto each lamination 61 and the complete slot 11 is formed when the laminations 61 are adhered together.

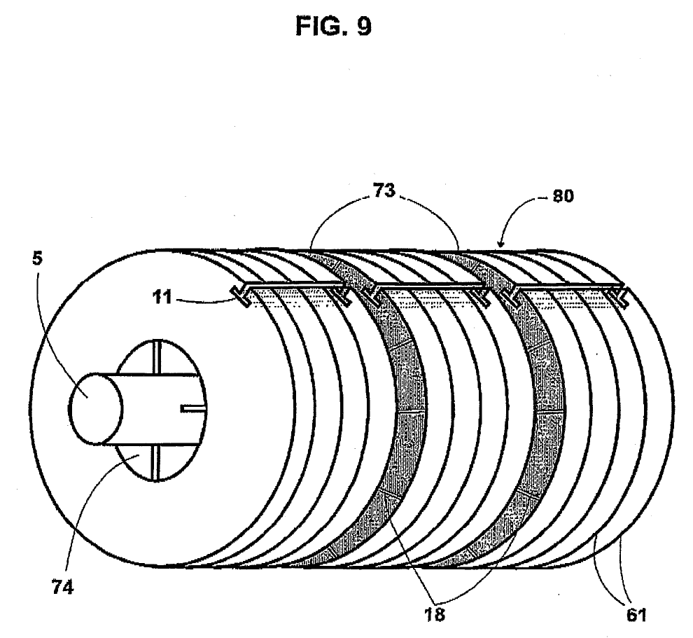

As illustrated in FIG. 9, for a vented laminated rotor 80 with ventilation gaps 73 the slot 11 cross-section is punched onto each lamination 61 and the complete slot 11 is formed when the laminations 61 are adhered together. At given intervals in the laminations there is a ventilation gap 73 that allows air flow from the shaft plenum 74 radially outward. The lamination 61 adjacent to each ventilation gap 73 is held by separator rods 18 that are mounted radially between the selected laminations.

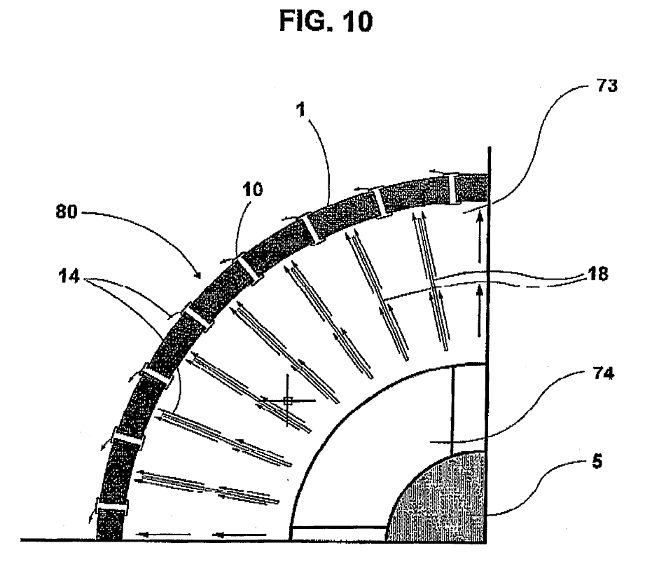

As illustrated in FIG. 10, cooling air 14 flows along the rotor shaft 5 and from the shaft plenum 74 radially outward through the rotor core, parallel to the separator rods 18, and passing by the gripping bars 10.

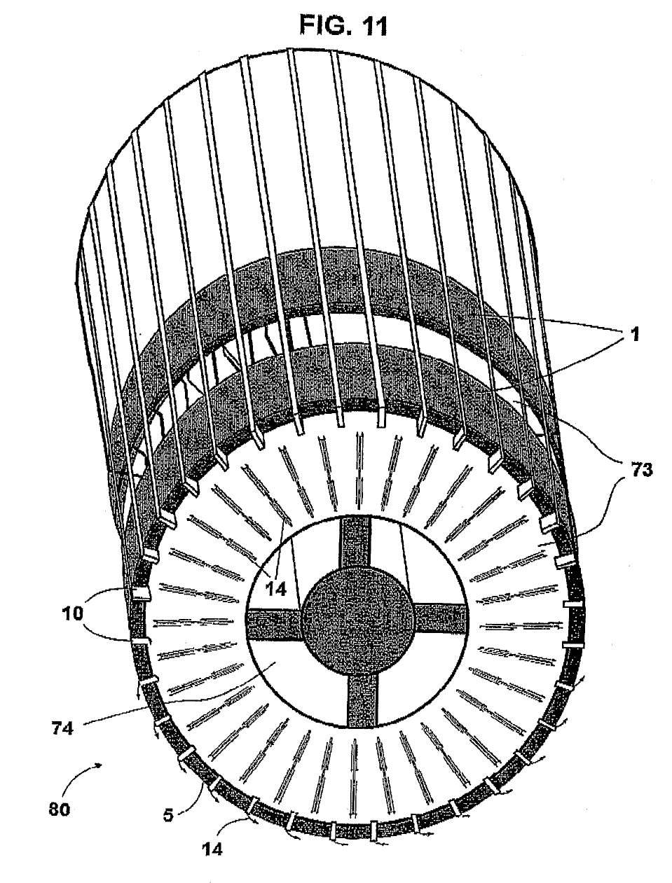

As further illustrated in FIG. 11, with this configuration the rotating gripping bars 10 protrude into the air gap beyond the magnets, and act as fans to move the air 14 within the air surrounding the rotor (the air gap 15) and facilitating rotor cooling. The ventilation gaps 73 are typically placed in the gaps between the longitudinally spaced magnets 1 to avoid the circumferentially spaced gripping bars 10 from blocking the flow entirely.

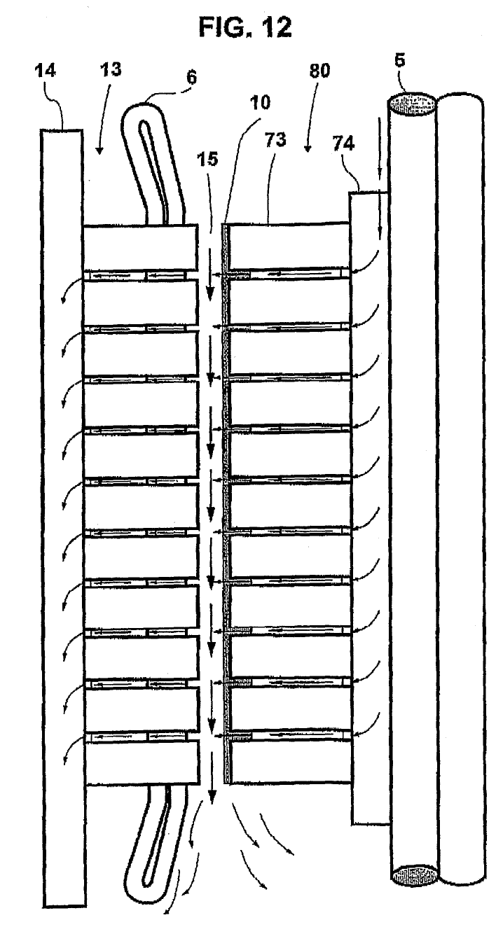

As illustrated in FIG. 12, the rotor is internally vented with ventilation gaps 73 that conduct cooling air 14 from the shaft plenum 74 radially outward through the rotor core 3 to the air gap 15. Ventilation gaps 73 are also made in the stator 13 to allow the air flow 14 to help remove heat from the stator 13 and stator windings 6.

### ALTERNATIVE EMBODIMENTS

While several illustrative embodiments of the invention have been shown and described, numerous variations and alternate embodiments will occur to those skilled in the art. For example, the magnets are mounted to the surface of the stator rather than the rotor and the gripping bar and slot apply to the stator; the rotor can be an outer rotor rotating about an armature; and the gripping bar has other than the “I” and dovetail shapes as, for example, a barbell with curved surfaces. Such variations and alternate embodiments, as well as others, are contemplated and can be made without departing from the spirit and scope of the invention as defined in the appended claims.

I claim:

1. A device to hold at least one magnetic flux producing permanent magnet onto a surface of an electrical machine comprising:
a. at least one slot recessed from the surface and extending from one end of the surface; and
b. at least one gripping bar inserted into an associated at least one slot having a protrusion extending past the surface to engage at least one magnet where at least one slot and at least one gripping bar are shaped to retain the at least one gripping bar within the associated at least one slot to hold the at least one engaged magnet onto the surface.

2. The device of claim 1 where further the at least one gripping bar is inserted into the associated at least one slot while heated and expanded and the at least one gripping bar is held within the associated at least one slot and engages at least one magnet as the at least one gripping bar cools and contracts.

3. The device of claim 1 further comprising an adhesive applied between the at least one magnet and the surface to further hold the at least one magnet to the surface.

4. The at least one gripping bar of claim 1 is further formed of non-ferromagnetic material in order not to interfere with the magnetic flux of the at least one magnet.

5. The gripping bar protrusion of claim 1 is further “I” beam shaped.

6. The magnet of claim 1 is further step shaped to engage the gripping bar protrusion.

7. The gripping bar protrusion of claim 1 is further dovetail shaped.

8. The magnet of claim 7 is further shaped with a sloped side to engage the gripping bar protrusion.

9. The device of claim 1 further providing a heat removal path from the volume surrounding the gripping bar.

10. The device of claim 9 where said volume is vented to conduct cooling air and said heat removal path comprises the air motion generated by the rotating gripping bar.

11. An electrical machine comprising:
a. a rotor and an encompassing stator, the rotor having a central axis;
b. at least one permanent magnet producing a magnetic flux;
c. a surface selected from the group consisting of the rotor surface furthest from the axis and the stator surface nearest to the axis;
d. at least one gripping device to hold at least one magnet onto the surface comprising:
i. a slot recessed from the surface and extending from one end to the surface; and
ii. a gripping bar inserted into the slot and extending past the surface to engage at lest one magnet;
where the gripping bar and slot are so shaped that the gripping bar is retained within the slot and the engaged at least one magnet is held onto the surface.

12. The device of claim 11 further comprising an adhesive applied between the at least one magnet and surface to further hold at least one magnet onto the surface.

13. The at least one gripping bar of claim 11 is further formed of non-ferromagnetic material in order to not interfere with the magnetic flux of the at least one magnet.

14. The gripping bar protrusion of claim 11 is further “I” beam shaped.

15. The magnet of claim 11 is step shaped to engage the gripping bar protrusion.

16. The gripping bar protrusion of claim 11 is further dovetail shaped.

17. The magnet of claim 16 is further shaped with a sloped side to engage the gripping bar.

18. The gripping protrusion of claim 11 further provides a heat removal path from the volume surrounding the slot.

19. The device of claim 18 where said volume is vented with gaps to conduct cooling air and said heat removal path comprises the air motion generated by the rotating gripping bar.

20. A method to hold at least one permanent magnet onto a surface of an electrical machine comprising the steps:
a. forming a slot recessed from the surface and beginning at one end of the surface;
b. forming a gripping bar shaped to fit within the slot with the shapes of the gripping bar and of the slot chosen to retain the gripping bar within the slot while the gripping bar protrudes beyond the surface and engages and holds the at least one magnet onto the surface; and
c. inserting the gripping bar into the slot while engaging the at least one magnet.

21. The method of claim 20 where further the gripping bar is inserted into the slot while the slot is hot and expanded and, when cooled and contracted, the slot holds the at least one magnet against the surface.

22. The method of claim 20 where further the surface is rotating and is centrally vented to pass cooling air, and the gripping bar acts as a fan to move the air and enhance cooling.
